(19) United States
(12) Patent Application Publication
(10) Pub. No.: US 2010/0282646 A1
(43) Pub. Date: Nov. 11, 2010

(54) METHOD AND UNIT FOR THE SEPARATION OF NON-FERROUS METALS AND STAINLESS STEEL IN BULK MATERIAL HANDLING

(76) Inventors: Eric Van Looy, Igualada (ES); Eva-Maria Gerosch, Igualada (ES)

Correspondence Address: D. PETER HOCHBERG CO. L.P.A., 1940 EAST 6TH STREET, CLEVELAND, OH, 44114, US

(21) Appl. No.: 12/452,604

(22) PCT Filed: Jul. 11, 2008
(86) PCT No.: PCT/EP2008/005694

§ 371 Date: Mar. 3, 2010

(30) Foreign Application Priority Data
Jul. 11, 2007 (ES) P200702024

(51) Int. Cl. B07B 15/00; B07C 5/34; B07C 5/344

(52) U.S. Cl. 209/12.1

(57) ABSTRACT

A method and unit for the separation of non-ferrous, ferrous and non-metal portions in bulk material handling, particularly for the recycling of materials for subsequent use, wherein the method comprises: the application of eddy currents for the separation of portions of non-ferrous and conductive materials that jump with respect to portions of the remaining material stream; the detection of metals in portions of materials by means of an analysis of the metals using electromagnetic sensors, and the separation of said metals by mechanical expulsion means, achieving the separation of metallic material portions, such as stainless steel, and others from the portions of non-metals. The unit comprises a first conveyor belt of the portions and eddy current (Foucault) separators, while a second conveyor belt includes electromagnetic metal sensors and selective expulsion means which are controlled by said electromagnetic metal sensors.

This application is a National Stage application of International Application No. PCT/EP2008/005694, filed on Jul. 11, 2008 and claims priority of Spanish Application Serial No. P200702024 filed Jul. 11, 2007.

### BACKGROUND OF THE INVENTION

1. Field of the Invention

The invention herein refers to a method and unit for the separation of non-ferrous and stainless steel in bulk material handling, particularly for the recycling of materials for subsequent use.

2. Description of the Prior Art

The metals must be classified in the most diverse fractions, particularly with regard to materials that have been ground into portions or fragments, from automobile recycling processes, treatment of electronic waste, recycling of reconstruction waste, treatment of municipal and domestic rubbish, voluminous raw materials and raw materials of all classes.

Related processes are described in the German Patent DE-A13513664. According to this document, an exact detection of the metals is impossible, particularly when it comes to aluminium. Nor is there sufficient information on the saving of ejection of bits.

The German Patent DE-A14014 969 does not describe an exact form of recognition for the detection of different materials. The object described in the German Patent document DE-A 1 4017129 only works at a relatively low transport speed.

Likewise, the method described in the German Patent DE-A142 35956 involves a complicated treatment process and time-consuming logic consideration.

In relation to the content of the German patent DE-A 1 4017 274, only fractions of a limited size can be processed due to channel system. Larger pieces would block the system.

In relation to documents of the German Patent DE 100 03.562 A1 and the European Patent EP-I 253 981 B1, the combination of metallic and optoelectronic sensors are described. Due to the high calculation performance, the complexity of the data processing, together with the highly demanding capacity requirements of the processor, this system is extremely complex and for sorting, clean material is required. Furthermore, it is impossible to reach a top quality classification when sorting dirty material.

### SUMMARY OF THE INVENTION

The method and unit for the separation of non-ferrous and stainless steel metals in the handling of bulk materials which is the object of this invention, present technical particularities aimed at obtaining a top-quality classification by means of a simple robust technology, which permits a cut in machinery investment and a reduction in the space required to carry out said sorting operation.

In fact, the main advantage of the invention is the combination of the simple eddy current technology (Foucault currents) and the tested technique of the electromagnetic metal sensor. Not only does this allow for a considerably lower investment, but at the same time allows for a reduction of a complete sorting plant to a compact one. This permits a high-quality separation of material at the initial stage of recycling, in which said materials have not yet been properly screened, for which the separation and distinction techniques of the materials must be effective.

Thus, the functioning of the unit includes initial eddy currents which are generated in conductor particles (Principle of eddy currents or Foucault currents) and, consequently, jump from the metal stream on the first conveyor belt, to at least one sorting or stream classification tray. Subsequently, a bar of highly sensitive electromagnetic sensors detect the remaining metals that have fallen onto the second conveyor belt. Using a system of mechanical fingers, blowers or others, placed at the end of the second conveyor belt and covering the entire width of the machine, the detected metals are ejected from the material stream. The mechanical fingers system can be independently operated according to the results of the electromagnetic sensors. The operated fingers eject single metal pieces from the stream that then becomes a third partial stream.

Considering the aforementioned processes, the “SCS Sensor Current Separator” is placed either behind a crushing unit followed by a magnet separator, or directly behind a screen and magnetic separator, which eliminates the ferrous-magnetic elements before sorting the remaining materials. The material fractions to be sorted at the entrance are preferably fed into the stream by a vibrating feeder or a conveyor belt above a first conveyor belt with the eddy currents near the exit end pulley of this first conveyor belt. The induction at the end of the first conveyor belt separates many of the non-ferrous materials outside of the feeding section (ejected stream). The stream of remaining materials, that has not been affected by the eddy currents, falls onto a second conveyor belt beneath the first conveyor belt. This fragment of materials still contains metals, particularly stainless steel and sheathed copper wire.

Selective metal recognition takes place at the end of the first conveyor belt by means of eddy currents. Immediately afterwards, the material stream passes over the end of the conveyor belt, where the eddy currents are generated in certain metals that pass, causing the latter to jump out of the main material stream to at least a first exit at the front.

Underneath, the conveyor belt and a sorting tray separate the metals that jump from the stream of the remaining materials. The remaining materials with metals are mainly stainless steel and are fed by the second conveyor belt over the electromagnetic sensor, situated beneath the belt at the end of the second conveyor belt. Here, all the stainless steel can be detected (and/or other metals) and after falling from the second conveyor belt, said metals can be ejected by specially designed mechanical devices. An additional sorting tray separates the ejection stream from the remaining materials and a third product stream is created, which consists mainly of stainless steel.

As it is impossible to know beforehand which of the inductive metals reacts sufficiently with eddy currents to jump far enough so as to land on the sorting tray, the metal sensor must be adapted to those metals that cannot be sufficiently induced. Said metals are principally stainless steel.

Owing to the combination of the eddy currents classifier with the electromagnetic metal sensors, the present invention allows the economic production, with simple means, of fractions of high quality non-ferrous materials, as well as other valuable materials. The combination of numerous sensors and separation units reduces considerably the size of the plant and, unlike other common classification units, performs more than two material classifications. The economic advantage results from the reduction in time requirements for a quality classification of the entering material.

As there are different reactions among the materials affected by the eddy currents, it has been anticipated that the first tray be divided into two trays, including a separating tray placed further away to separate those non-ferrous metals which, due to their conductivity being more affected by the eddy currents and, therefore, jump a greater distance as is the case with aluminium. A nearer separating tray collects the non-ferrous materials that have not been able to jump as far since they are less affected by the eddy currents.

The existing expulsion means at the end of the second conveyor belt and which has the task of re-routing the stainless steel and sheathed copper cables portions from the non-metallic portions, can be of diverse characteristics.

In a first configuration, said expulsion means is made up of a transversal bar of height-adjustable mechanical fingers, for example by means of an electric or analogous pusher, in such a way that the affected portion falls by gravity if the mechanical finger is not activated, or is re-routed to an additional sorting tray if the mechanism is activated. As the different mechanical fingers react to the corresponding electromagnetic sensors with the appropriate delay, the detected stainless steel metal particles are duly expelled at the end of the second conveyor belt.

Alternatively, the expulsion mechanisms can be made up of a bar of blowing valves, connected to an installation of compressed air to carry out the same function as the aforementioned mechanical fingers on the portions of stainless steel. Said blowing valves are connected to the compressed air system of the plant or installation.

### BRIEF DESCRIPTION OF THE DRAWINGS

So as to complement the description given herein and with the purpose of facilitating the comprehension of the characteristics of the invention, the present descriptive report is accompanied by a set of drawings where, with an illustrative and non limiting character, the following are represented:

FIG. 1 shows a block diagram of the machine of the present invention equipped with the mechanically moved expulsion means.

FIG. 2 shows a block diagram of the machine of the present invention equipped with an expulsion means through the action of blowing valves by means of compressed air.

### DETAILED DESCRIPTION OF THE PREFERRED EMBODIMENTS

As can be observed in the aforementioned figures, the present invention includes two stacked conveyor belts (1, 2), with a vibrating feeder (3) placed at the entrance of the first conveyor belt (1). Said feeder (3) feeds the ferrous metal, non-ferrous metal and non-metal portions (4a, 4b, 4c, 4d) of the materials to be classified. The first conveyor belt (1) includes near the extreme part of its exit a generation of eddy currents (5) to make certain non-ferrous conductor metal portions (4a, 4b) jump, to end up on two consecutive sorting trays (61, 62) to create two exits of non-ferrous metal portions (4a, 4b), including a first exit of the non-ferrous metal portions (4a) of those materials that are more susceptible to jump far, such as aluminium, and a second sorting tray (62) of non-ferrous metal portions (4b) of other jumping metals. The ferrous metal and non-metal portions (4c, 4d) that are not affected by the eddy currents (5) fall between the first conveyor belt (1) and the sorting tray (62) at the beginning of the second conveyor belt (2).

Said second conveyor belt (2) has underneath a transversal bar of electromagnetic sensors (7) and at the end, an expulsion bar that drops the non-metal or non-metallic material portions (4c) in an appropriate exit, or if they are detected as ferrous metals by the electromagnetic sensors (7), their activation to re-route said ferrous metals to a sorting tray (63) at another metal exit where said metals are mainly stainless steel and sheathed copper cables that do not react to eddy currents (7).

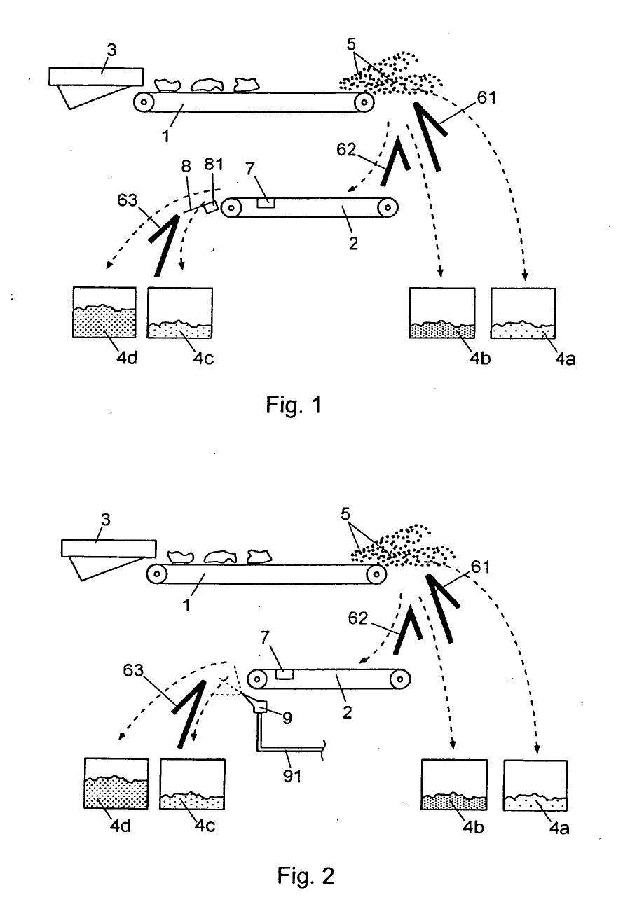

The expulsion means is mainly made up of oscillating mechanical fingers (8), as shown in FIG. 1, and operated by electromagnets (81) as pushers.

In an alternative implementation, shown in FIG. 2, the expulsion means is made up of a series of blowing valves (9) placed transversally across the width of the second conveyor belt (2), said valves (9) being associated with the corresponding electromagnetic sensors (7) for their corresponding operation and fed from an installation (91) of compressed air.

Once the nature of the invention has been sufficiently described, as well as an example of the preferred implementation given, it must be noted for required purposes that the materials, shape, size and arrangement of the described elements may be modified, provided said modification does not imply an alteration in the essential characteristics of the invention that are claimed hereinafter.

1. A method for the separation of a stream of material comprising ferrous metal portions, non-ferrous metal portions and non-metal portions in bulk material handling, said method comprising the following steps:
applying eddy currents to the stream of material for separating the non-ferrous portions from the ferrous and non-metal portions by causing the non-ferrous metal portions to jump with respect to the remaining stream of material
detecting the ferrous metal portions by analyzing the ferrous metal and non-metal portions using at least one electromagnetic sensor, and
separating the ferrous metal portions from the non-metal portions by using an expulsion.

2. Unit for the separation of a stream of material comprising ferrous metal portions, non-ferrous metal portions and non-metal portions in bulk material handling, said unit comprising:
a first conveyor belt for transporting the stream of material,
eddy current separators for separating the non-ferrous metal portions from the ferrous and non-metal portions by causing the non-ferrous metal portions to jump with respect to the remaining stream of material,
at least one first sorting tray for diverting the non-ferrous metal portions that jump away from the ferrous metal and non-metal portions,
a second conveyor belt located underneath said first conveyor belt, said second conveyor belt receiving the ferrous metal and non-metal portions, said second conveyor belt further comprising at least one electromagnetic metal sensor for detecting the ferrous metal portions,
expulsion structure controlled by said at least one electromagnetic metal sensor, said expulsion structure separating the ferrous metal portions from the non-metal portions, and
a second sorting tray for diverting the ferrous metal portions from the non-metal portions.

3. Unit, according to claim 2, wherein the non-ferrous metal portions comprise a first non-ferrous metal portion and a second non-ferrous metal portion, and the first non-ferrous metal portion jumps further from the second non-ferrous metal portion, said unit further comprising:
an additional sorting tray for diverting the first non-ferrous portion away from the second non-ferrous portion.

4. Unit, according to claim 2, further comprising a vibrating feeder at the entrance of the first conveyor belt for the progressive entrance of the material stream.

5. Unit, according to claim 2, wherein the eddy currents are applied at the end of the first conveyor belt.

6. Unit, according to claim 2, wherein the at least one electromagnetic metal sensor is calibrated for the detection of the ferrous metal portions.

7. Unit, according to claim 2, wherein the at least one electromagnetic sensor is a plurality of electromagnetic sensors, the electromagnetic sensors being arranged as a transversal bar on the second conveyor belt for detecting the ferrous metal portions.

8. Unit, according to claim 2, wherein the expulsion structure further comprises a transversal bar of height-adjustable mechanical fingers connected to at least one electromagnet for separating the ferrous metal portions from the non-metal portions.

9. Unit, according to claim 2, wherein the expulsion structure further comprises a transversal bar of valves of compressed air, connected to at least one electromagnet for separating the ferrous metal portions from the non-metal portions.

10. Unit, according to claim 2, wherein said ferrous portions comprise stainless steel.

11. Unit, according to claim 2, wherein said ferrous portions comprise sheathed copper cables.

12. Unit, according to claim 2, wherein said non-ferrous portions comprise aluminum.
